(19) United States
(12) Patent Application Publication
(10) Pub. No.: US 2018/0092720 A1
(43) Pub. Date: Apr. 5, 2018

(54) DUAL HUED DENTAL IMPLANT AND METHOD OF MAKING SAME

(71) Applicant: Implant Direct Sybron International LLC, Thousand Oaks, CA (US)

(72) Inventors: Ines Aravena, Santa Rosa Valley, CA (US); Kevin Sean Corcoran, Corona, CA (US)

(21) Appl. No.: 15/723,294

(22) Filed: Oct. 3, 2017

Related U.S. Application Data
(60) Provisional application No. 62/483,578, filed on Apr. 10, 2017.
(60) Provisional application No. 62/403,941, filed on Oct. 4, 2016.

(51) Int. Cl. A61C 13/08; A61C 8/00; A61C 13/00

(52) U.S. Cl. CPC A61C 13/082; A61C 8/0089; A61C 8/0068; A61C 8/0078; A61C 13/0012; A61C 8/0075; A61C 13/0007

(57) ABSTRACT

A dental implant for implantation into an oral environment of a patient includes a body having a coronal end, an apical end, an inner surface adjacent to coronal end, and an outer surface extending from the coronal end to the apical end. A first area of the dental implant is a first color and a second area of the dental implant is a second area. A method of making a dental implant includes providing a dental implant having a body with a coronal end, an apical end, an inner surface adjacent the coronal end, and an outer surface extending from the coronal end to the apical end; coloring a first area of the dental implant a first color; and coloring a second area of the dental implant a second color.

### CROSS REFERENCE TO RELATED APPLICATION

This application claims priority to U.S. Provisional Application Ser. No. 62/403,941, filed Oct. 4, 2016 (pending), and U.S. Provisional Application Ser. No. 62/483,578, filed Apr. 10, 2017 (pending), the disclosures of which are incorporated by reference herein in their entirety.

### TECHNICAL FIELD

The present invention is generally related to the field of dental implants, and more particularly to dental implants colored so as to be aesthetically pleasing and possibly color coded for proper application.

### BACKGROUND

Edentulism, the condition of being toothless to some extent, may be treated by the implantation of a dental assembly. These assemblies require certain components to rest comfortably and securely in the patient's oral cavity. The implant fixture, also known as the dental implant or simply the implant, is the part of the dental assembly that becomes fused with the patient's jaw bone. The implant is available in both cylinder and screw-type varieties and is typically made from titanium or a titanium alloy. In the normal course, the implant is buried within the gingiva of the oral cavity and an abutment is used as an intermediary between the implant and a dental prosthesis. The abutment may be screwed onto the implant and positioned at and above the patient's gum line. The dental prosthesis is then placed over and secured to the abutment. The prosthesis is designed to look and function as a natural tooth.

Some current dental implants are provided with some color aspects. In this regard, current dental implants are typically colored for two main purposes: color coding and aesthetics. By way of example, some dental implants may include a single color on their prosthetic interfacing platform as a means of identifying the size of the platform and the proper abutment for use with the implant. Essentially, this is a color coding system to allow the physician to quickly identify the proper tools and components to use when performing the implantation. The single color used in these applications is typically applied through an anodization process. Occasionally, dental implants are colored on the neck of the implant to better blend the implant into the soft tissue of the gingiva. In some circumstances, the relatively darker color of the titanium surface of the implant can show through as an undesirable dark spot when covered by a thin layer of soft tissue or if the tissue recedes, thereby exposing parts of the implant that stand out visibly in contrast to the surrounding soft tissue. Providing a gingival coloring to aspects of the implant helps blend the implant into the oral environment, making the implant difficult to see and improving the aesthetics of the implant during use.

To date, dental implants having only a single color are commercially available, i.e., either the color coding anodization on the prosthetic-interfacing platform, or the aesthetic colorization on the neck of the implant. In some applications, however, single color dental implants have some drawbacks. By way of example, while colored dental implants are designed to blend in with the gingiva of the oral environment, there may be applications where it is desirable for the implant to blend in with additional or alternative structures in the oral environment. In this regard, there may be times when the dental implant, such as in a one-stage implant, shows through the dental prosthesis, such as an artificial tooth or the like, and therefore detracts from the aesthetic value of the prosthetic. Dental implants having a dual color scheme, however, are not generally commercially available to dental practitioners and consumers. Manufacturers continually strive to improve the function, aesthetics, and use of dental implants. Accordingly, manufacturers and users of dental implants would find dual hued implants desirable.

Therefore, a need exists for a dental implant having more than a single color associated with the implant. More particularly, there is a need for a dual hued dental implant that can provide color coding on the prosthetic-interfacing platform and blend in with the soft tissue in the oral environment. Additionally, there is a need for a dual hued dental implant that can blend in with more than one structure in the oral environment. There is also a need for a method of applying multiple colors to the same dental implant.

### SUMMARY

A dental implant for implantation into an oral environment of a patient includes a body having a coronal end, an apical end, an inner surface adjacent to coronal end, and an outer surface extending from the coronal end to the apical end. A first area of the dental implant is a first color and a second area of the dental implant is a second area.

In one embodiment, the first area of the dental implant includes at least a portion of the inner surface and the first color of the dental implant may provide a color coding. In this embodiment, the first color of the dental implant may correspond, for example in a predetermined manner, to a particular abutment and/or one or more tools for use with the dental implant. The dental implant includes a bore formed in the coronal end of the implant configured to facilitate the coupling of an abutment to the dental implant, wherein the bore defines the inner surface that includes the first color. Further to this embodiment, the second area of the dental implant includes at least a portion of the outer surface. The second color may be configured to blend the dental implant in with structure in the oral environment. For example, the second color of the dental implant may be configured to blend the dental implant in with the surrounding gingiva, and therefore may be gingival colored.

In another embodiment, the first area of the dental implant includes at least a portion of the outer surface. In this embodiment, the first color of the dental implant may be configured to blend the dental implant with a first structure in the oral environment. For example, the first color of the dental implant may be configured to blend the dental implant in with the surrounding teeth, and therefore may be tooth colored. Further to this embodiment, the second area of the dental implant includes at least a portion of the outer surface and the second color may be configured to blend the dental implant with a second structure in the oral environment. For example, the second color of the dental implant may be configured to blend the dental implant in with the surrounding gingiva, and therefore may be gingival colored.

In one embodiment, the dental implant includes a gingiva-engaging portion and a bone-engaging portion, wherein at least the gingiva-engaging portion includes the second color. The dental implant may be a one-stage implant and thus further include a prosthesis-engaging portion, wherein the prosthesis-engaging portion includes the first color. At least a portion of the bone-engaging portion of the dental implant may be coated with an osseointegration promoting agent, such as hydroxyapatite. Additionally, a portion of the bone-engaging portion of the dental implant may be blasted so as to, for example, roughen the at least a portion of the bone-engaging portion. Furthermore, blasting may also be used to remove color from selected portions of the dental implant.

In one embodiment, the dental implant includes a first portion configured to receive the dental prosthesis, a second portion configured to extend through the gingiva, and a third portion configured to engage bone tissue. In this embodiment, the first color is on the first portion and the second color is on the second portion.

In another embodiment, a dental assembly for implantation into an oral environment of a patient includes a dental implant, and a dental element configured to be coupled to the dental implant. The dental implant includes a body having a coronal end, an apical end, an inner surface adjacent the coronal end, and an outer surface extending from the coronal end to the apical end. A first area of the dental implant is a first color and a second area of the dental implant is a second color. In one embodiment, the dental element includes an abutment and the abutment corresponds, such as in a predetermined manner, to the first color of the dental implant. The dental assembly may then further include a dental prosthesis configured to be coupled to the abutment. In another embodiment, the dental implant is a one-stage implant and the dental element comprises a dental prosthesis configured to be coupled to, such as directly to, the dental implant.

In yet another embodiment, a method of making a dental implant includes providing a dental implant having a body with a coronal end, an apical end, an inner surface adjacent the coronal end, and an outer surface extending from the coronal end to the apical end; coloring a first area of the dental implant a first color; and coloring a second area of the dental implant a second color.

In one embodiment, coloring the first area of the dental implant the first color further includes coloring at least a portion of the inner surface of the dental implant the first color. In an alternative embodiment, coloring the first area of the dental implant the first color further includes coloring at least a portion of the outer surface of the dental implant the first color. Moreover, coloring the second area of the dental implant the second color further comprises coloring at least a portion of the outer surface of the dental implant the second color. Coloring the first area of the dental implant may be performed before or after coloring the second area of the dental implant. In one embodiment, coloring the first area the first color includes anodizing at least a portion of the dental implant to the first color. Alternatively, coloring the first area the first color includes coating at least a portion of the dental implant. Furthermore, coloring the first area the first color includes the combination of anodizing and coating at least a portion of the dental implant. Coloring the second area the second color includes anodizing at least a portion of the dental implant the second color. Alternatively, coloring the second area the second color includes coating at least a portion of the dental implant the second color. Furthermore, coloring the second area the second color includes the combination of anodizing and coating at least a portion of the dental implant.

In still a further embodiment, at least a portion of the outer surface of the dental implant may be blasted. Blasting may be used to roughen up the outer surface of the dental implant and/or to remove coloration of the implant at selected locations. Furthermore, at least a portion of the surface of the dental implant may be coated with an osseointegration promoting agent, such as hydroxyapatite.

### BRIEF DESCRIPTION OF THE DRAWINGS

The accompanying drawings, which are incorporated in and constitute a part of this specification, illustrate embodiments of the invention and, together with a general description of the invention given above and the detailed description given below, serve to explain the principles of the invention.

FIG. 1 is a diagrammatic top view of one embodiment of a dental implant in accordance with one embodiment of the present invention;

FIG. 2 is a diagrammatic side view of the dental implant shown in FIG. 1;

FIG. 3 illustrates an exemplary method for forming the dual-hued dental implant in accordance with an embodiment of the invention;

FIG. 4 is a diagrammatic perspective view of a dental implant in accordance with another embodiment of the present invention;

FIG. 5 is a cross-sectional view of the dental implant shown in FIG. 4; and

FIG. 6 is cross-sectional view of a dental assembly include the implant shown in FIG. 4 and a dental prosthesis in an oral environment of a patient.

### DETAILED DESCRIPTION

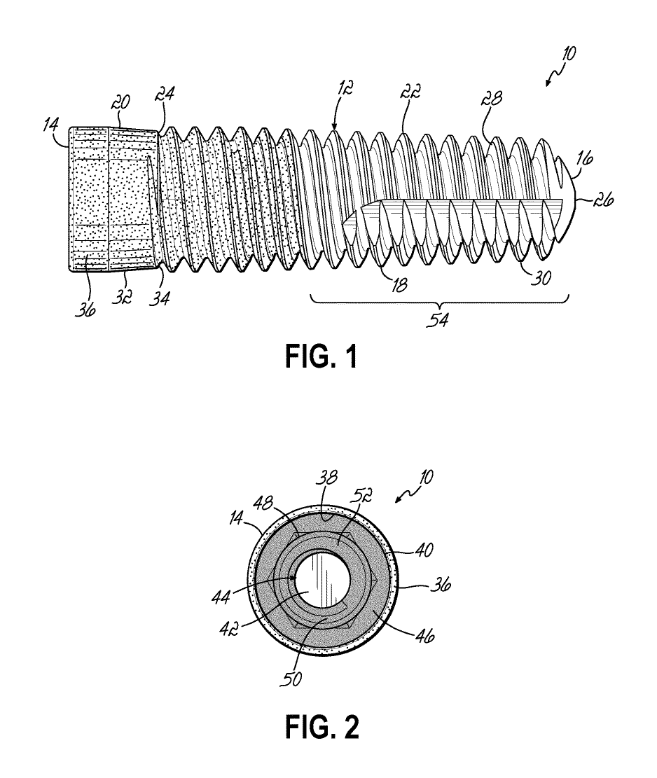

FIG. 1 illustrates a dental implant 10 in accordance with an exemplary embodiment of the present invention. The implant 10 includes a generally cylindrical body 12 having a first coronal end 14 and a second apical end 16. The coronal end 14 is configured to be coupled to an abutment, which is then configured to be coupled to a dental prosthesis (not shown), and the apical end 16 is configured to be positioned within the bone of the maxillary or mandibular jaw, for example.

Accordingly, and in an exemplary embodiment, the dental implant 10 includes a bone-engaging portion 18 and a gingiva-engaging portion 20. The bone-engaging portion 18 includes a generally cylindrical body 22 having a proximal end 24 adjacent the coronal end 14, a distal end defined by a distal tip 26 of the implant 10, and an outer surface 28. As noted above, the bone-engaging portion 18 is configured to be embedded within bone tissue of the patient to securely fix the dental implant, and thus the dental assembly, to the patient. To this end, the outer surface 28 of the bone-engaging portion 18 may include a thread pattern 30 to facilitate the securement of the implant 10 within the bone tissue. A wide range of thread patterns may be used on the outer surface 28 of the bone engaging portion 18. By way of example, the progressive thread pattern disclosed in U.S. application Ser. No. 15/206,357, assigned to the Assignee of the present application and incorporated by reference herein in its entirety, may be used as the thread pattern 30.

In an exemplary embodiment, the thread pattern 30 may extend substantially the full length of the bone-engaging portion 18. In an alternative embodiment, however, the thread pattern 30 may extend for only a portion of the length of the bone-engaging portion 18. The bone-engaging portion 18 may have a constant outer diameter or may have a tapered configuration wherein the outer diameter decreases in a direction toward the distal tip 26. With the dental implant 10 positioned within the patient, the bone-engaging portion 18 may not be visible through the bone tissue. Accordingly, the portions of the bone-engaging portion 18 may not be colored and takes on the natural color of the implant (e.g., dark gray) itself.

The gingiva-engaging portion 20 includes a generally cylindrical body 32 having a proximal end at the coronal end 14 of the implant 10, a distal end 34, and an outer surface 36. As noted above, the gingiva-engaging portion 20 is configured to be embedded within the gingiva tissue of the patient. In one embodiment, the gingiva-engaging portion 20 may have a generally constant outer diameter, which may be equal to, greater than, or less than the diameter of the bone-engaging portion 18. In an alternative embodiment, however, the gingiva-engaging portion 20 may have a tapered configuration where the outer diameter generally increases in a direction toward the coronal end 14 of the implant 10. In still a further alternative embodiment, the gingiva-engaging portion 20 may include both tapered portions and constant diameter portions. By way of example, the outer diameter of the gingiva-engaging portion 20 adjacent the coronal end 14 may be generally constant, while the outer diameter of the gingiva-engaging portion 20 adjacent the bone-engaging portion 18 may be generally tapered, as illustrated, for example, in FIG. 1. It should be recognized, however, that other configurations are possible within the scope of the invention.

In an exemplary embodiment, the outer surface 36 of the gingiva-engaging portion 20 may be substantially smooth along its length. Such a smooth configuration is configured to increase patient comfort by minimizing irritation points on the dental implant 10. Additionally, the length of the gingiva-engaging portion 20 may vary depending on the specific application. In any event, the length is configured to generally correspond to the thickness of the gingiva at which the dental implant 10 is being inserted such that the coronal end 14 of the dental implant 10 is generally flush with the gum line of the patient.

As best illustrated in FIG. 2, the coronal end 14 of the implant 10 includes a bore, which may be configured as a blind bore 38. The bore 38 includes a proximal end 40 open to the coronal end 14 of the dental implant 10, a closed distal end 42, and an interior wall 44 extending therebetween. The bore 38 has a diameter generally less than the diameter of the dental implant 10 adjacent the coronal end 14 to define a shoulder 46. The bore 38 generally includes a tool-receiving portion 48 and a fastener-receiving portion 50. The tool-receiving portion 48 is adjacent the proximal end 40 of the bore 38 and includes engaging features configured to facilitate the mating of a tool for engaging with the implant 10 for positioning the implant 10 with the bone tissue of a patient. The engaging features, for example, may include a hexagonal profile or a series of ridges and grooves as is generally known in the art. The fastener-engaging portion 50 extends distally from the tool-engaging portion 48 and has a diameter generally less than the diameter of the tool-engaging portion 48. The interior wall 44 along at least a portion of the fastener-engaging portion 50 includes threads 52 configured to mate with threads on a fastener for securing an abutment to the dental implant 10.

In accordance with an aspect of the present invention, the dental implant 10 has a dual hue or color so as to on the one hand provide a color coding scheme for the dental practitioner, and on the other hand to further blend the dental implant 10 in with structure in the oral environment of a patient. More particularly, in an exemplary embodiment, a first portion of the dental implant 10 may be configured to provide a color code scheme to the dental practitioner, and a second portion of the dental implant 10 may be configured to blend with structure in the oral environment. Even more particularly, the gingiva-engaging portion 20 of the dental implant 10 may be colored so as to blend in with the gingiva of the patient. In this way, the naturally dark color of the implant does not show through either of the gingiva or the prosthesis, and the overall aesthetics of the dental assembly is improved. Additionally, the prosthetic-interfacing platform of the dental implant 10 may be colored to provide a color code system that facilitates the coordinated implantation of the dental assembly by the dental practitioner.

In accordance with an aspect of the present invention, at least a portion, and preferably the entirety of the outer surface 36 of the gingiva-engaging portion 20, may be colored in order to blend this portion of the dental implant 10 in with the surrounding gingiva. Even a portion of the bone-engaging portion 18 may also be colored in order to blend in with the surrounding gingiva. This is denoted in FIG. 1 by a first stippled pattern on the gingiva-engaging portion 20 (and on a portion of the bone-engaging portion 18). The color of the gingiva-engaging portion 20 may be described by a color space using the commonly used CIE (Commission Internationale de l'Eclariage) L*, a*, b* conventions, which represents colors in a three-dimensional Cartesian coordinate system. L*, or “value”, is a measure of luminance or lightness, and is represented on the vertical axis (black is 0 and white is 100). The a*, b* coordinates, are a measure of chromaticity and are represented on the horizontal coordinates, with positive a* representing red and negative a* representing green, and positive b* representing yellow and negative b* representing blue. In selecting the correct shades for gingiva-engaging portion 20, the color components, hue, chroma and value, may also be evaluated. Hue is the dimension of color that enables us to distinguish one family of color from another; chroma defines the relative intensity of a particular color, i.e., the more intense a color is, the higher its chroma level; and value describes the relative whiteness or blackness of a particular color, i.e., the brighter the color, the higher its value. In addition to these components, characteristics such as opacity, fluorescence, and translucency may also be considered during the determination of the correct shades for the implant.

More particularly, the gingiva-engaging portion 20 is generally pink-colored or gingival-colored to generally match the color of the gingival tissue. Gingival-colored, as described herein, is meant to refer to CIE L*, a*, b* color coordinates that fall within, or approximately within, the color space described as follows: L* between about 40 to 75; a* between about 12 to 25; and b* between about 6 to 20. These ranges are exemplary and values outside these ranges may also be possible. By providing the gingiva-engaging portion 20 with a matching color, the dental implant 10 is less visible and therefore more aesthetically pleasing. Moreover, in the event that the gingival tissue should recede such that part of the implant 10 is exposed, the implant should remain camouflaged within the oral environment.

In accordance with a further aspect of the invention, at least a portion of the prosthetic-interfacing platform may be colored so as to provide a color code system to the dental practitioner. As illustrated in FIG. 2, the prosthetic-interfacing platform may be provided by internal aspects or surfaces of the dental implant 10, such as those internal surfaces provided by the bore 38. In this regard, at least portions of the shoulder 46, portions of the tool-receiving portion 48, and/or portions of the fastener-receiving portion 50 may be colored so as to be visible to a practitioner when a practitioner looks down on the top (e.g., in the direction of the apical end) of the dental implant 10. This is denoted in FIG. 2 by a second stippled pattern on internal aspects of the bore 38. Notably, the color code portions of the dental implant 10 are provided on internal aspect of the implant such that once the dental assembly is completed (e.g., the abutment is coupled to the dental implant), the color coded portion is no longer visible to the dental practitioner. Once the dental practitioner visualizes the color code on the dental implant 10, the appropriate abutment (e.g., the appropriate size, type of abutment), as well as the appropriate tools or other elements that facilitates implantation, may be readily identified. A wide range of colors, such as greens, blues, reds, etc., may be used to provide the color code scheme on the dental implant 10. The color used for the color code is typically different from the color on the outer surface of the dental implant 10.

To manufacture dental implant 10 having the dual hues, a dental implant may first be manufactured according to known techniques that will not be described in further detail herein. A first portion of the dental implant 10 may then be colored a first color and a second portion of the dental implant 10 may be colored a second color, which may be different from the first color. The first portion may include an internal portion of the dental implant 10, while the second portion may include an outer portion of the dental implant 10. In various embodiments, the colors may be applied to the dental implant 10 through an anodization process, a coating process, or a combination of the two processes. Other processes may also be possible to provide dual hues.

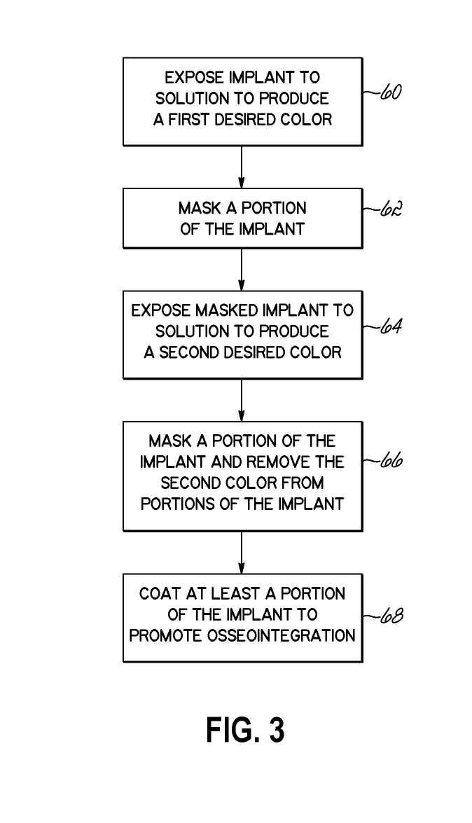

In an exemplary embodiment and as schematically illustrated in FIG. 3, substantially the entirety of the dental implant 10, including the internal aspects of the bore 48 and the outer surfaces of the dental implant 10, may be anodized a first color. Anodization processes are generally known to those of ordinary skill in the art, but include exposing the dental implant 10 to an acid bath solution. The amount of time the dental implant 10 is exposed to the solution correlates to a resulting color in a known manner. Thus, the dental implant 10 may be exposed to the solution for a time that corresponds to the desired color of a first portion of the dental implant 10. This aspect is illustrated in step 60 in FIG. 3. By way of example, the dental implant 10 may be exposed to the acid bath solution for an amount of time such that the dental implant 10, and more particularly, the bore 38 has a color corresponding to the desired color of the color code scheme (e.g., green, blue, red, etc.).

Subsequent to this step, the internal portions of the dental implant 10 having the first color may be masked or otherwise covered. More particularly, the bore 38 of the dental implant 10 may be masked such that further processing of the dental implant 10 (either through an anodization process or a coating process) will not alter the color of the dental implant 10 of the internal portions. Masking techniques are well known to those of ordinary skill in the art, and thus will not be described herein in further detail. This is illustrated in step 62 in FIG. 3.

With a desired portion of the dental implant masked, the implant 10 may be colored a second color. By way of example, the dental implant 10 may be masked such that at least a portion of the outer surface (including substantially the entirety of the outer surface) of the dental implant 10 remain unmasked and therefore subject to the second color. In one embodiment, this second color may be achieved through an anodization process. In this regard, the masked dental implant 10 may be subjected to the acid bath solution for a period of time (which is determined in a known manner) until the unmasked portions of the dental implant 10 reach their desired color. As discussed above, in an exemplary embodiment, the second color may be selected to generally match the color of the gingiva in the oral environment. This is illustrated in step 64 in FIG. 3.

Following the step above, substantially the entirety of the outer surface of the dental implant 10 will have the second color. For various reasons and in some applications, this may be undesirable. Thus, in an optional further method step, the second color may be removed from select portions of the dental implant 10. The length of or degree to which the dental implant 10 includes the second color may vary in view of the particular usage envisioned for the implant. By way of example and without limitation, it may be desirable to have at least a section of the bone-engaging portion 18 of the dental implant 10 free of the second color. More particularly, it may be desirable to have a section 54 (FIG. 1) of the bone-engaging portion 18 adjacent the distal tip 26 free of the second color. In an exemplary embodiment, the dental implant 10 may be masked such that the selected section 54 of the outer surface of the dental implant 10 is unmasked or exposed. The dental implant 10 may then be subjected to blasting, for instance with a soluble blast media process. The optional blasting process may be used to roughen the outer surface of the dental implant 10 to help promote osseointegration. Exemplary SBM include aluminum oxide or titanium oxide. These SBM are generally known to one of ordinary skill in the art and may be selected based on the specifications of the particular application for which the implant will be used. This is illustrated in step 66 in FIG. 3.

In a further optional method step, at least a portion of the implant 10 may be coated to promote osseointegration of the dental implant 10 into the bone tissue. By way of example, at least a portion of the dental implant 10 may be coated with osseointegration promoting agent, such as hydroxyapatite. Other coatings, however, are also possible and within the scope of the present invention. In an exemplary embodiment, it may be desirable to have at least a section of the bone-engaging portion 18 of the dental implant 10 include such a coating. More particularly, it may be desirable to have a section 54 (FIG. 1) of the bone-engaging portion 18 adjacent the distal tip 26 free of the second color. This is illustrated in step 68 in FIG. 3.

The method described above involves the use of anodization to provide the color to the dental implant. It should be recognized that the color may also be provided to the dental implant 10 by coating, or a combination of anodizing and coating the dental implant. By way of example, the dental implant 10 may be coated with a material, such as titanium nitride, having the desired color. Various coating techniques are known to those of ordinary skill in the art and thus will not be described in further detail herein.

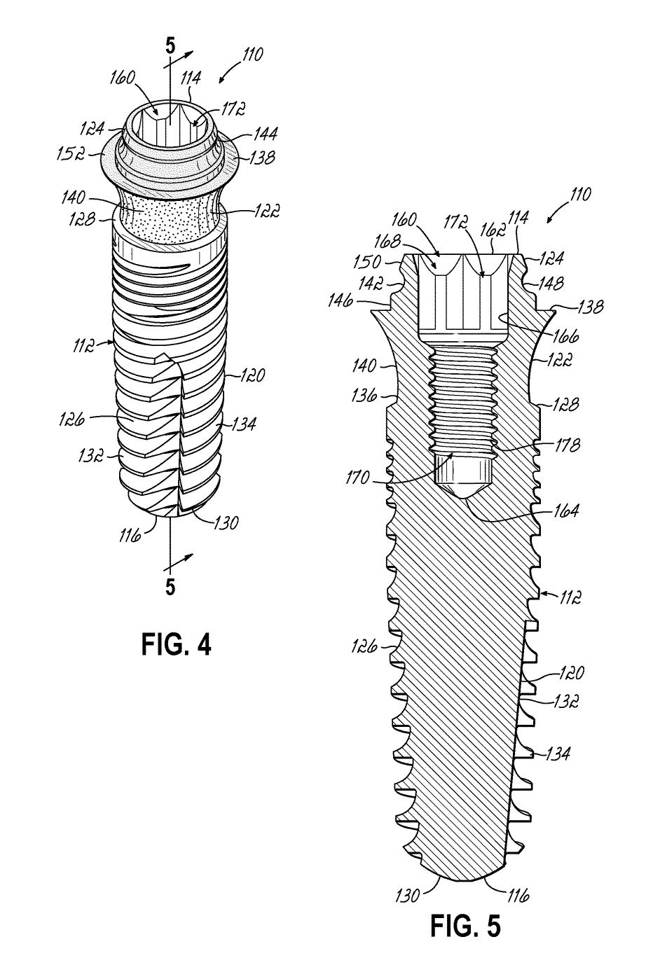

Another embodiment in accordance with aspects of the invention are illustrated in FIGS. 4-6. In this embodiment, the dual hue or color is provided on the outer surface of the dental implant such that the dental implant may blend in with more than one structure in the oral environment. For example, in an exemplary embodiment a first color on the dental implant may facilitate blending the dental implant in with the teeth in the oral environment, and a second color may facilitate blending the dental implant in with the gingiva in the oral environment.

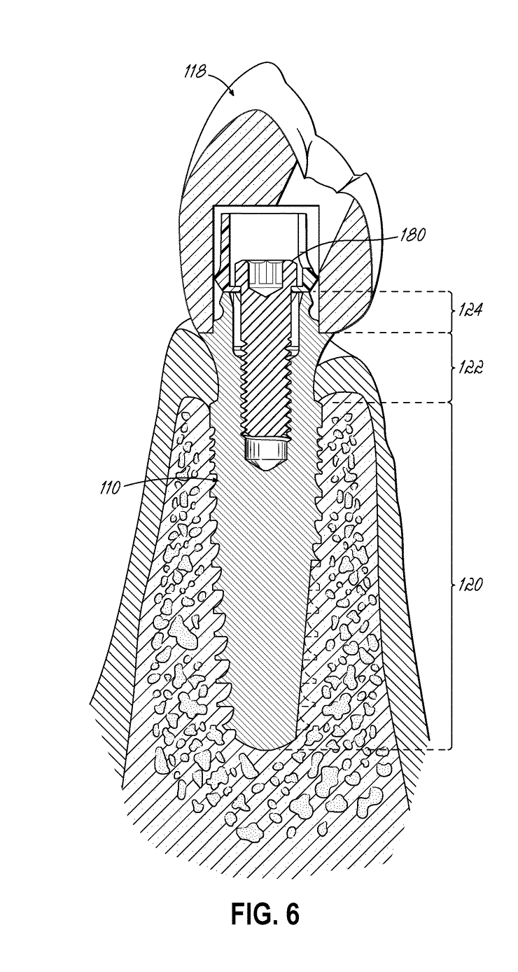

In this regard, FIG. 4 illustrates a dental implant 110 in accordance with an exemplary embodiment of the present invention. The dental implant 110 includes a generally cylindrical body 112 having a first coronal end 114 and a second apical end 116. The coronal end 114 is configured to be coupled to a dental prosthesis 118 and the apical end 116 is configured to be positioned within the bone of the maxillary or mandibular jaw, for example (FIG. 6). In one embodiment, the dental implant 110 may be a one-stage implant which couples directly to the dental prosthesis 118 without an intervening abutment and extends through the soft tissue of the gingiva. In such an embodiment, the implant 110 includes a bone-engaging portion 120, a gingiva-engaging portion 122, and a prosthesis-engaging portion 124.

In accordance with an aspect of the present invention and similar to the above, the dental implant 110 has a dual hue so as to blend with more than a single structure in the oral environment of a patient. More particularly, in an exemplary embodiment, a first portion of the dental implant 110 is configured to blend in with a first structure in the oral environment, and a second portion of the dental implant 110 is configured to blend with a second structure in the oral environment. Even more particularly, the second gingiva-engaging portion 122 may be colored so as to blend with the gingiva of the patient, and the prosthesis-engaging portion 124 may be colored so as to blend in with the particular prosthesis that is being positioned in the oral environment of the patient. In this way, the naturally dark color of the dental implant does not show through either of the gingiva or the prosthesis, and the overall aesthetics of the dental assembly is improved.

The bone-engaging portion 120 includes a generally cylindrical body 126 having a proximal end defined by a shoulder 128, a distal end defined by a distal tip 130 of the dental implant 110, and an outer surface 132. The shoulder 128 may be generally flat or be slightly angled, as illustrated in FIG. 4. As noted above, the bone-engaging portion 120 is configured to be embedded within bone tissue of the patient to securely fix the dental assembly to the patient. To this end, the outer surface 132 of the bone-engaging portion 120 includes a thread pattern 134 to facilitate the securement of the dental implant 110 within the bone tissue. A wide range of thread patterns may be used on the outer surface 132 of the bone-engaging portion 120. By way of example, the progressive thread pattern described above may be used as the thread pattern 134. In an exemplary embodiment, the thread pattern 134 may extend substantially the full length of the bone-engaging portion 120. In an alternative embodiment, however, the thread pattern 134 may extend for only a portion of the length of the bone-engaging portion 120. The bone-engaging portion 120 may have a constant outer diameter or may have a tapered configuration wherein the outer diameter decreases in a direction toward the distal tip 130. With the dental implant 110 positioned within the patient as illustrated in FIG. 7, the bone-engaging portion 120 is typically not visible through the bone tissue. Accordingly, the bone-engaging portion 120 may not be colored and takes on the natural color of the implant (e.g., dark gray) itself.

The intermediate gingiva-engaging portion 122 includes a generally cylindrical body 136 having a proximal end at a second shoulder 138, a distal end at the first shoulder 128, and an outer surface 140. As noted above, the gingiva-engaging portion 122 is configured to be embedded within the gingiva tissue of the patient as illustrated in FIG. 6. In one embodiment, the gingiva-engaging portion 122 may have a generally constant outer diameter, which may be less than the diameter of the diameter of the bone-engaging portion 120 to define the first shoulder 128. In an exemplary embodiment, however, the gingiva-engaging portion 122 may have a tapered configuration where the outer diameter generally increases in a direction from the first shoulder 128 to the second shoulder 138, i.e., in a direction from the distal end to the proximal end of the gingiva-engaging portion 122. By way of example, the outer diameter of the gingiva-engaging portion 122 at the proximal end may be greater than the diameter of the bone-engaging portion 120 at its proximal end. However, other sizes are possible within the scope of the invention. In an exemplary embodiment, the outer surface 140 of the gingiva-engaging portion 122 may be substantially smooth along its length. Such a smooth configuration is configured to increase patient comfort by minimizing irritation points on the implant 110. Additionally, the length of the gingiva-engaging portion 122 may vary depending on the specific application. In any event, the length is configured to generally correspond to the thickness of the gingiva at which the implant 110 is being inserted such that the second shoulder 138 is generally flush with the gum line of the patient (FIG. 6).

In accordance with an aspect of the present invention, at least a portion and preferably the entirety of the outer surface 140 of the gingiva-engaging portion 122 may be colored in order to blend this portion of the dental implant 10 with the surrounding gingiva. This is denoted in FIG. 4 by a first stippled pattern on the gingiva-engaging portion 122. The color of the gingiva-engaging portion 122 may be provided by that described above in regard to the previous embodiment. Thus, the gingiva-engaging portion 122 is generally pink-colored or gingival-colored to generally match the color of the gingival tissue. By providing the gingiva-engaging portion 122 with a matching color, the dental implant 110 is less visible and therefore more aesthetically pleasing. Moreover, in the event that the gingival tissue should recede such that part of the dental implant 110 is exposed, the implant should remain camouflaged.

The prosthesis-engaging portion 124 includes a generally cylindrical body 142 having a proximal end corresponding to the proximal end 114 of the dental implant 110, a distal end at the second shoulder 138, and an outer surface 144. As noted above, the prosthesis-engaging portion 124 is configured to be received within or engaged with the prosthesis 118 that is to be coupled to the dental implant 110. In an exemplary embodiment, the prosthesis-engaging portion 124 includes a base 146 adjacent the distal end, an intermediate annular groove 148 and a chamfered tip 150 at the proximal end. The base 146 includes a generally constant outer diameter and extends for a relatively short length (e.g., 5%-30% of the length of the prosthesis-engaging portion 124. The diameter of the base 146 at the distal end is generally less than the diameter at the proximal end of the gingiva-engaging portion 122 so as to define a generally flat surface 152 at second shoulder 138. The annular groove 148 is generally U-shaped and has a length slightly longer than the length of the base 146. The diameter of the groove at the end adjacent the proximal end of the prosthesis-engaging portion 124 is smaller than the diameter at the distal end of the groove (e.g., about 5%-20%). The chamfered tip 150 then extends from the proximal end of the groove 140 and has an outer diameter that decreases in the direction of the proximal end 114 of the implant 110. In an exemplary embodiment, the outer surface 144 of the prosthesis-engaging portion 124 may be generally smooth along its length. Additionally, the length of the chamfered tip 150 may be about the same as the base 146. However, different lengths are possible depending on the application.

In accordance with an aspect of the invention, at least a portion and preferably the entirety of the outer surface 144 of the prosthesis-engaging portion 124 may be colored in order to blend this portion of the dental implant 110 with the artificial tooth to which it is coupled. This is denoted in FIG. 4 by a second stippled pattern different from the stippled pattern on the gingiva-engaging portion 122. Similar to the above, the prosthesis-engaging portion 124 may be described by a color space using the CIE L*, a*, b* color convention. The prosthesis-engaging portion 124 is generally tooth colored. The colors of human teeth appear to range from a light, almost white-tan to a light brown, and occupy a specific color space. By shading or coloring the prosthesis-engaging portion 124 to be generally tooth colored, that portion of the dental implant 110 will be camouflaged with the dental prosthesis 118 and the surrounding dentition. As used herein, tooth colored refers to CIE L*, a*, b* color coordinates that fall within, or very close to, the color space defined as follows: L* between about 50 to 80; a* between about −3 to 10; and b* between about −1 to 6. These ranges are exemplary and values outside these ranges may also be possible. The colors of human teeth also vary from the apical portion of a tooth near the roots to the coronal portion of the tooth. This is more apparent in anterior teeth (i.e., incisors and canines) because the thickness of the dentin layer decreases from the apical portion to the coronal portion of the tooth. Thus, the color of the more distal portion of the prosthesis-engaging portion 124 of the dental implant 110 may include alternatively colored portions to account for possible different colors that may be used in a prosthetic to match the natural color(s) of a tooth. For example, some portions of the prosthetic tooth (corresponding to portions of the natural tooth with thicker dentin) may be colored or shaded differently (i.e., more yellow or darker). In this regard, the CIE L*, a*, b* color coordinates may be defined as follows: L* between about 60 to 80; a* between about −3 to 10; and b* between about 12 to 36. Similarly, portions near the incisal or coronal portion of the prosthetic tooth may be colored or shaded in a lighter manner (i.e., more white). In this regard, the CIE L*, a*, b* color coordinates may be defined as follows: L* between about 50 to 75; a* between about −1 to 10; and b* between about −1 to 30.

As best illustrated in FIG. 5, the proximal end 114 of the dental implant 110 includes a bore, which may be configured as a blind bore 160. The bore 160 includes a proximal end 162 open to the coronal end 114 of the dental implant 10, a closed distal end 164, and an interior wall 166 extending therebetween. The bore 160 generally includes a tool-receiving portion 168 and a fastener-receiving portion 170. The tool-receiving portion 168 is adjacent the proximal end 162 of the bore 160 and includes engaging features 172 configured to facilitate the mating of a tool for engaging with the dental implant 110 for positioning the dental implant 110 with the bone tissue of a patient. The engaging features 172, for example, may be a series of ridges and grooves as is generally known in the art. The fastener-engaging portion 170 extends distally from the tool-engaging portion 168 and has a diameter generally less than the diameter of the tool-engaging portion 168. The interior wall 166 along at least a portion of the fastener-engaging portion 170 includes threads 178 configured to mate with threads on a fastener 180 for securing the prosthesis 118 to the dental implant 10 (FIG. 6).

The manufacture of dental implant 110 is generally similar to that described above in reference to FIG. 3, for example. To manufacture dental implant 110 having the dual hues, a dental implant may first be manufactured according to known techniques that will not be described in further detail herein. In various embodiments, the colors may be applied to the dental implant 110 through an anodization process, a coating process, or a combination of the two processes. Other processes may be possible to provide dual hues. By way of example and without limitation, in a first optional step, a portion of the dental implant 110 may be masked such that only a first portion of the outer surface is exposed. Subsequently, the dental implant 110 may then be exposed to an acid bath solution and kept in the bath for an amount of time appropriate to produce a first color on a first area of the outer surface of the dental implant 110. The dental implant 110 may then be masked so as to expose only a second portion of the outer surface of the dental implant 110. The dental implant 110 may then be exposed to the acid bath solution for an amount of time appropriate to produce a second color on a second area of the outer surface of the dental implant 110. The first and second portions may correspond to at least a portion of the gingival-engaging portion 122 and the prosthesis-engaging portion 124, respectively, as described above. As an alternative to the anodization process described above. The dental implant 110 may be coated with a material, such as titanium nitride, having the desired color. In a further embodiment, a combination of anodization and coating processes may be used with or without masking to produce the dual hued dental implant 110 as described above. Additionally, at least a portion of the bone-engaging portion 120 may be coated with an osseointegration agent, such as hydroxyapatite, to promote integration of the dental implant 110 into the bone of the patient. Further processing steps, such as blasting or the like, may also be performed on the dental implant 110 to facilitate its use in the oral environment of a patient.

While the present invention has been illustrated by a description of various preferred embodiments and while these embodiments have been described in some detail, it is not the intention of the inventor to restrict or in any way limit the scope of the appended claims to such detail. Additional advantages and modifications will readily appear to those skilled in the art. By way of example, unless required by a certain application, the coloring of the dental implant with the first and second colors may occur in any order. Thus, the various features of the invention may be used alone or in any combinations depending on the needs and preferences of the user.

What is claimed is:

1. A dental implant for implantation into an oral environment of a patient, the dental implant comprising a body having a coronal end, an apical end, an inner surface adjacent the coronal end, and an outer surface extending from the coronal end to the apical end, wherein a first area of the dental implant is a first color and a second area of the dental implant is a second color.

2. The dental implant of claim 1, wherein the first area of the dental implant includes at least a portion of the inner surface.

3. The dental implant of claim 2, wherein the first color of the dental implant provides a color coding.

4. The dental implant of claim 2, wherein the first color of the dental implant corresponds to a particular abutment and/or tool for use with the dental implant.

5. The dental implant of claim 2, wherein the dental implant includes a bore formed in the body at the coronal end of the dental implant, the bore defining the inner surface that includes the first color.

6. The dental implant of claim 2, wherein the second area of the dental implant includes at least a portion of the outer surface.

7. The dental implant of claim 6, wherein the second color of the dental implant blends the dental implant with the oral environment.

8. The dental implant of claim 7, wherein the second color of the dental implant is gingival colored.

9. The dental implant of claim 1, wherein the first area of the dental implant includes at least a portion of the outer surface.

10. The dental implant of claim 9, wherein the first color of the dental implant blends the dental implant with the oral environment.

11. The dental implant of claim 10, wherein the first color of the dental implant is tooth colored.

12. The dental implant of claim 9, wherein the second area of the dental implant includes at least a portion of the outer surface.

13. The dental implant of claim 12, wherein the second color of the dental implant blends the dental implant with the oral environment.

14. The dental implant of claim 13, wherein the second color of the dental implant is gingival colored.

15. The dental implant of claim 1, wherein the dental implant includes at least a gingiva-engaging portion and a bone-engaging portion, wherein at least the gingiva-engaging portion includes the second color.

16. The dental implant of claim 15, wherein the dental implant is a one-stage implant further including a prosthesis-engaging portion, wherein the prosthesis-engaging portion includes the first color.

17. The dental implant of claim 15, wherein the bone-engaging portion is blasted.

18. The dental implant of claim 1, wherein the dental implant includes a first portion configured to receive the dental prosthesis, a second portion configured to extend through the gingiva, and a third portion configured to engage bone tissue.

19. The dental implant of claim 18, wherein the first color is on the first portion and the second color is on the second portion.

20. A dental assembly for implantation into an oral environment of a patient, the dental assembly comprising:
a dental implant, the dental implant comprising a body having a coronal end, an apical end, an inner surface adjacent the coronal end, and an outer surface extending from the coronal end to the apical end, wherein a first area of the dental implant is a first color and a second area of the dental implant is a second color; and
a dental element configured to be coupled to the coronal end of the dental implant.

21. The dental assembly of claim 20, wherein the dental element comprises an abutment, wherein the abutment corresponds to the first color of the dental implant.

22. The dental assembly of claim 21, wherein the dental assembly further comprises a dental prosthesis configured to be coupled to the abutment.

23. The dental assembly of claim 20, wherein the dental implant is a one-stage implant and the dental element comprises a dental prosthesis.

24. A method of making a dental implant, comprising:
providing a dental implant having a body, a coronal end, an apical end, an inner surface adjacent the coronal end, and an outer surface extending from the coronal end to the apical end;
coloring a first area of the dental implant a first color; and
coloring a second area of the dental implant a second color.

25. The method of claim 24, wherein coloring the first area of the dental implant the first color further comprises coloring at least a portion of the inner surface of the dental implant the first color.

26. The method of claim 24, wherein coloring the first area of the dental implant the first color further comprises coloring at least a portion of the outer surface of the dental implant the first color.

27. The method of claim 24, wherein coloring the second area of the dental implant the second color further comprises coloring at least a portion of the outer surface of the dental implant the second color.

28. The method of claim 24, wherein coloring the first area of the dental implant is performed prior to coloring the second area of the dental implant, or vice versa.

29. The method of claim 24, wherein coloring the first area of the dental implant the first color further comprises anodizing at least a portion of the dental implant, coating at least a portion of the dental implant, or a combination of anodizing and coating at least a portion of the dental implant.

30. The method of claim 24, wherein coloring the second area of the dental implant the second color further comprises anodizing at least a portion of the dental implant, coating at least a portion of the dental implant, or a combination of anodizing and coating at least a portion of the dental implant.

31. The method of claim 24, further comprising blasting at least a portion of the surface of the dental implant.
